(19) United States
(12) Patent Application Publication
(10) Pub. No.: US 2024/0416506 A1
(43) Pub. Date: Dec. 19, 2024

(54) REMOTELY ACTUATED ROTARY ACTUATOR WITH TORQUE MULTIPLICATION

(71) Applicant: CONTORO INC., Austin, TX (US)

(72) Inventors: William Wu, Austin, TX (US); Michael Normand, Austin, TX (US); Daniel Nguyen, League City, TX (US); Youngmok Yun, Austin, TX (US); Rohit John Varghese, Austin, TX (US)

(21) Appl. No.: 18/740,840

(22) Filed: Jun. 12, 2024

Related U.S. Application Data
(60) Provisional application No. 63/508,556, filed on Jun. 16, 2023.

(51) Int. Cl. B25J 9/10; B25J 19/02; F16C 1/18

(52) U.S. Cl. CPC B25J 9/1045; B25J 19/02; F16C 1/18

(57) ABSTRACT

Embodiments include a component of a lightweight and low-cost robotic exoskeletons for teleoperation applications.

### CROSS-REFERENCE TO RELATED APPLICATION

This application claims priority to U.S. Provisional Patent Application No. 63/508,556 filed on Jun. 16, 2023 and entitled “Remotely Actuated Rotary Actuator With Torque Multiplication”, the content of which is hereby incorporated by reference.

### BACKGROUND

Teleoperation (or remote operation) indicates operation of a system or machine at a distance. It is most commonly associated with robotics and mobile robots but can be applied to a whole range of circumstances in which a device or machine is operated by a person from a distance. Teleoperation may be used in numerous fields including entertainment systems, industrial machinery (e.g., remote operation of a robot in hazardous environments), remotely operated vehicles, remote surgery, and the like.

### BRIEF DESCRIPTION OF THE DRAWINGS

Features and advantages of embodiments of the present invention will become apparent from the appended claims, the following detailed description of one or more example embodiments, and the corresponding figures. Where considered appropriate, reference labels have been repeated among the figures to indicate corresponding or analogous elements.

FIG. 1 provides a perspective view of an embodiment of a driven unit.

FIGS. 2A and 2B provide side views of the embodiment in various orientations.

FIG. 3 provides a cross-sectional view of the embodiment.

FIGS. 4A, 4B provide perspective views of the embodiment with a different cable routing versus the routing of FIG. 1.

FIG. 5 provides a perspective view of an embodiment of a driving unit.

FIG. 6 provides a cross-sectional view of the embodiment.

FIGS. 7A and 7B provide partial perspective views of the embodiment in various orientations.

FIGS. 8A and 8B provide cross-sectional views of the embodiment in various orientations.

### DETAILED DESCRIPTION

Reference will now be made to the drawings wherein like structures may be provided with like suffix reference designations. In order to show the structures of various embodiments more clearly, the drawings included herein are diagrammatic representations of structures. Thus, the actual appearance of the fabricated structures, for example in a photo, may appear different while still incorporating the claimed structures of the illustrated embodiments (e.g., walls may not be exactly orthogonal to one another in actual fabricated devices). Moreover, the drawings may only show the structures useful to understand the illustrated embodiments. Additional structures known in the art may not have been included to maintain the clarity of the drawings. For example, not every layer of a device is necessarily shown. “An embodiment”, “various embodiments” and the like indicate embodiment(s) so described may include particular features, structures, or characteristics, but not every embodiment necessarily includes the particular features, structures, or characteristics. Some embodiments may have some, all, or none of the features described for other embodiments. “First”, “second”, “third” and the like describe a common object and indicate different instances of like objects are being referred to. Such adjectives do not imply objects so described must be in a given sequence, either temporally, spatially, in ranking, or in any other manner. “Connected” may indicate elements are in direct physical or electrical contact with each other and “coupled” may indicate elements co-operate or interact with each other, but they may or may not be in direct physical or electrical contact. Phrases such as “comprising at least one of A or B” include situations with A, B, or A and B.

Embodiments help enable lightweight and low-cost robotic exoskeletons for teleoperation applications. Humans may use a device that includes an embodiment and the device may sense the forces and movements of the wearer and transfer them to another remote robot. Also, additional forces and movements experienced by the remote robot could be sensed and applied to the human using the device.

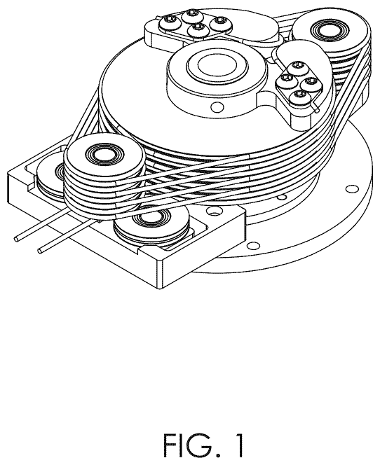

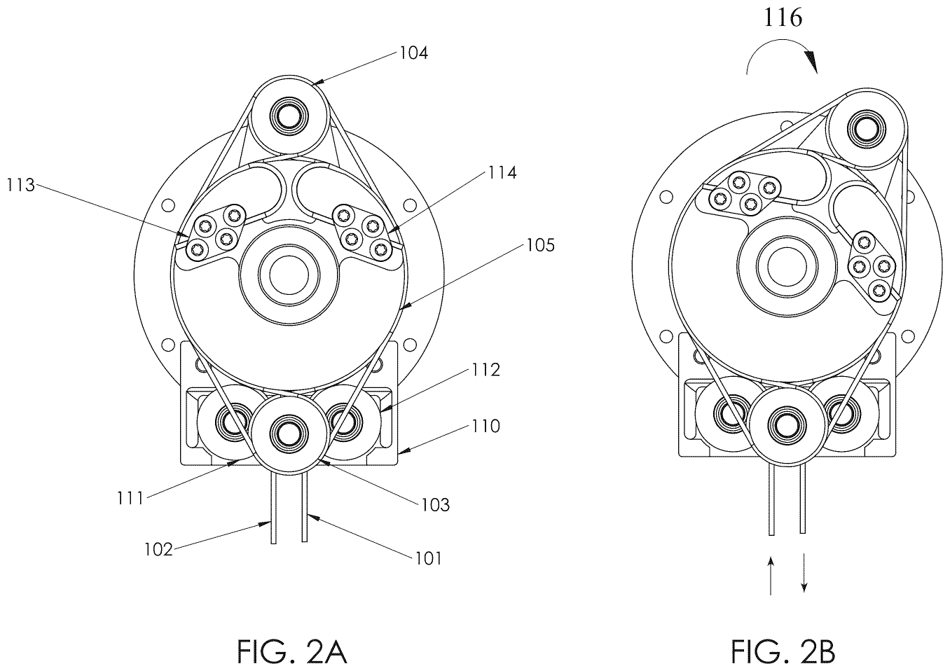

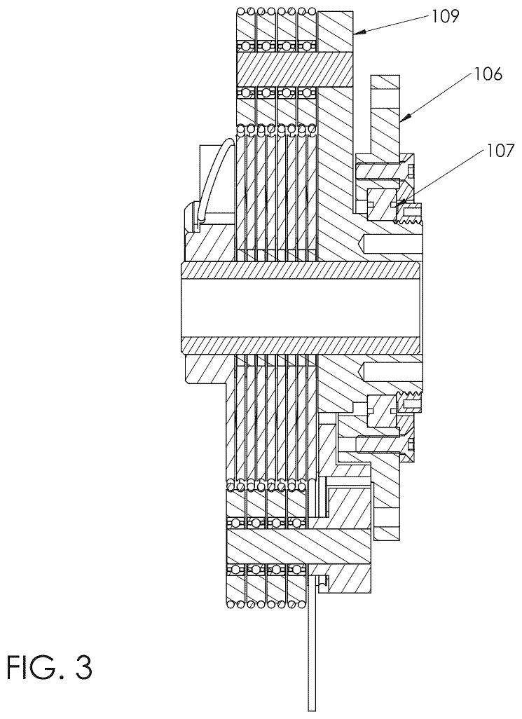

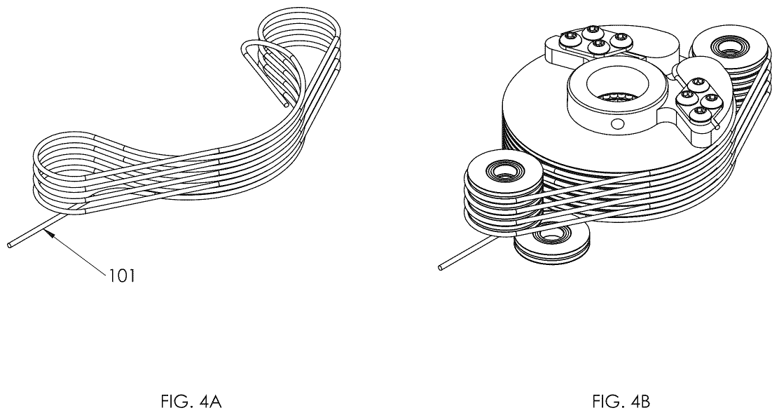

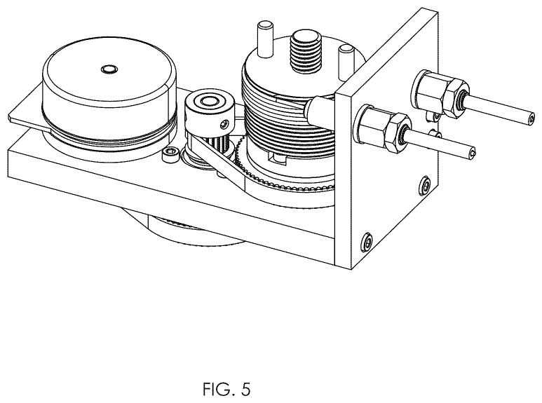

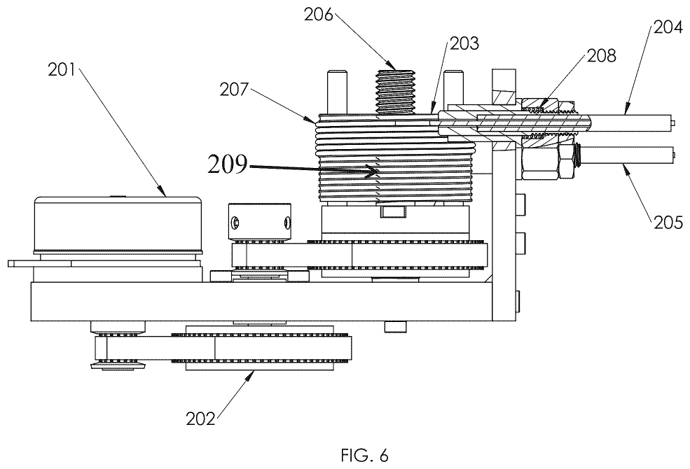

An embodiment includes a single cable connecting a driving unit (FIGS. 5-8B) and a driven unit (FIGS. 1-4B), the cable passes through a Bowden tube between the driving and driven units to enable remote actuation.

For FIGS. 1-4B (series 1XX) and FIGS. 5-8B (series 2XX), the following elements are shown:
101. Cable for clockwise torque
102. Cable for counterclockwise torque
103. Fixed block
104. Moving block
105. Central pulley
106. Driven unit housing
107. Driven unit output bearing
108. N/A
109. Driven unit output link
110. Fixed block force sensor
111. Fixed block input guide pulley for counter clockwise torque cable
112. Fixed block input guide pulley for clockwise torque cable
113. Counter clockwise torque cable end fixation point
114. Clockwise torque cable end fixation point
115. Axis
116. Rotating force
201. Motor
202. Motor speed reducer
203. Spool
204. Bowden cable
205. Bowden cable
206. Fixed shaft with thread feature
207. Cable
208. Bowden cable tensioning spring
209. Threaded inner diameter of spool
210. Protuberance
211. Distance

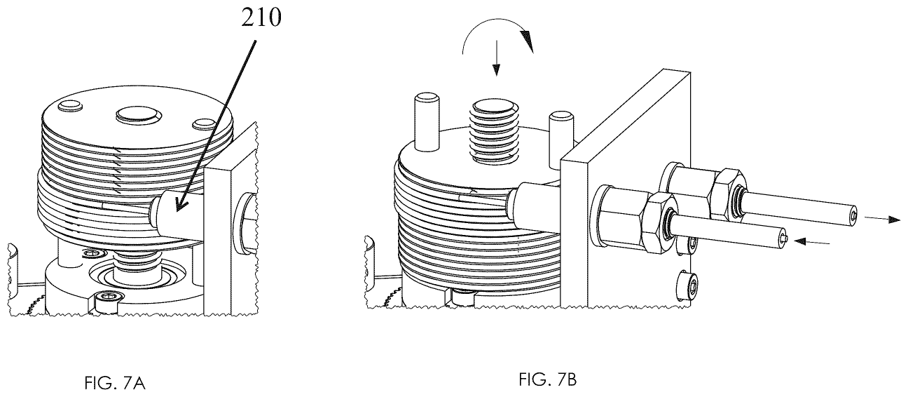

The driving unit consists of a motor 201 which rotates a pulley 203 with a helical groove cut in its outer diameter and a helical feature (such as a screw thread, shown in phantom at 209) on its inner diameter with the same handedness and pitch as the groove on its outer diameter. Cable 207 is wound around the outside of the pulley such that the cable fits into the exterior helical groove and makes at least one complete wrap around the spool. The pulley is mounted on a fixed shaft 206 with a matching helical feature (i.e., shaft 206 cooperates with inner threads 209) such that when the motor rotates the pulley, the pulley will translate a proportional amount. For example, see how the pulley translates between first and second positions in FIGS. 7A to 7B. The net effect is that as the motor rotates the pulley, the cable will move with the pulley and the point at which the cable wraps onto the pulley and the point at which the cable wraps off the pulley stay fixed in space relative to the fixed central shaft. For example, note how the cable exits protuberance 210 at the same location in FIGS. 7A and 7B despite the amount of able on the spool changing between the two figures. As a result, the length of cables 204, 205 do not change when the actuator system actuates (e.g., rotates a shoulder joint of a robotic arm) so tension may be more precisely controlled.

The driven unit consists of a block and tackle system which acts around a central pulley 105. The block and tackle consist of a fixed block 103 with at least one pulley and a moving block 104 with at least one pulley. The fixed block and the central pulley axis 115 are fixed relative to each other, while the moving block rotates about the central pulley axis. The central pulleys may also rotate freely about the central pulley axis. Each end of the cables 101, 102 from the drive unit is installed into the driven unit such that as the cable passes between the fixed and moving block, the cables wraps around the central pulley. The cable ends terminate at counter clockwise torque cable end fixation point 113 and clockwise torque cable end fixation point 114. The central pulley redirects the force from the cable such that as tension is applied to either end of the cable from the drive unit, the cable applies a rotating force 116 to the moving block (and driven unit output link 109) which actuates the output of the driven unit (see driven unit output bearing 107, which is coupled to driven unit housing 106). As mentioned above, the cables are terminated such that the ends of the cable are fixed relative to the moving block or to the fixed block. A force sensor 110 may also be incorporated such that the forces experienced by the fixed block may be measured. Forces experienced by the fixed block will be proportional to the output torque of the actuator thus enabling output torque measurement. The driven unit may also include fixed block input guide pulley 111 for the counter clockwise torque cable and fixed block input guide pulley 112 for the clockwise torque cable.

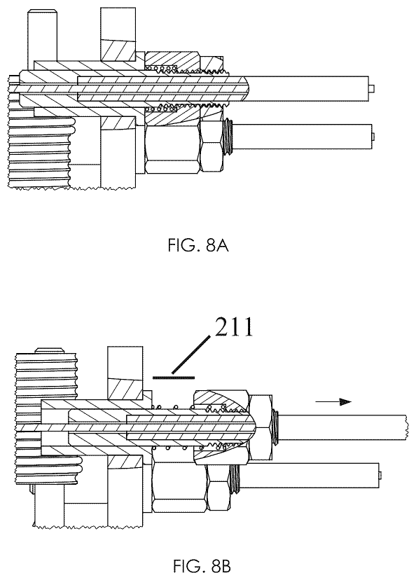

Between the driving unit and the driven unit, each end of the cable from the drive unit passes through a Bowden tube 204, 205 to enable the driving unit and the driven unit to move relative to each other. A spring tensioner mechanism applies a pushing force to the end of each Bowden tube which maintains tension on the cable. In other words, as cables 204, 205 fatigue and relax over time, their length may change. However, to maintain consistent tension in the cables over time, FIGS. 8A, 8B show how the overall length of travel for the cable may change by extending spring 208. For example, slack in a cable may be countered by lengthen its travel path by distance 211.

### Examples

Example 1. A system comprising: driving unit; a driven unit configured to be driven by the driving unit; first and second cables coupling the driving unit to the driven unit; wherein the driving unit comprises: a motor; a spool upon which the first and second cables are wound; a shaft upon which the spool is mounted; wherein the driven unit comprises: a pulley; a dynamic block; a static block.

Example 2. The system of Example 1, wherein: the spool includes a central aperture and the shaft is included in the central aperture; the spool includes an outer surface with a groove; the first and second cables are included in the groove; the central aperture is threaded with threads; the shaft is threaded with threads that cooperate with the threads of the central aperture.

Example 3. The system of Example 2, wherein: the groove on the outer surface of the spool includes a first pitch; the threads of the central aperture include a second pitch that equals the first pitch.

Example 4. The system of Example 3, wherein: the motor is configured to rotate the spool; the spool is configured to translate along the shaft in response to the motor rotating the spool.

Example 5. The system of Example 4, wherein the first and second cables are configured to move in opposing directions in response to the motor rotating the spool.

Example 6. The system of Example 4, wherein the first cable is configured to maintain a consistent tension while the spool translates along the shaft in response to the motor rotating the spool.

The consistent tension promotes accuracy in sensing forces (e.g., torque) exerted by or on the driven unit.

Example 7. The system of Example 4, wherein: the driving unit includes a channel; the first cable is included in the channel; the first cable unwinds from the spool and enters the channel at a static angle while the spool translates along the shaft in response to the motor rotating the spool.

Example 8. The system of Example 7 comprising a spring to increase a distance between the channel and the spool as an overall length of the first cable increases over time.

The consistent tension of the cable is promoted by increasing the distance the cable must travel between the driving and driven units as the cable slackens over time. This consistent tension promotes accuracy in sensing forces (e.g., torque) exerted by or on the driven unit.

Example 9. The system of Example 7 comprising a spring to increase a distance between the channel and the spool as the first cable fatigues over time.

Example 10. The system according to any of claims 1 to 9, wherein the first and second cables are not monolithic with each other.

Example 11. The system according to Example 10, wherein the first and second cables terminate at the driven unit.

Example 12. The system according to any of claims 1 to 11 wherein: the pulley rotates about a central axis; the dynamic block is configured to rotate about the central axis in response to the motor rotating the spool.

Example 13. The system of Example 12, wherein the first cable is configured to maintain a consistent tension while the dynamic block rotates about the central axis in response to the motor rotating the spool.

The consistent tension promotes accuracy in sensing forces (e.g., torque) exerted by or on the driven unit.

Example 14. The system of Example 13, wherein the driven unit includes a force sensor to sense force exerted on the static block.

Example 15. The system of Example 13, wherein the driven unit includes a force sensor to sense torque of the driven unit.

The foregoing description of the embodiments of the invention has been presented for the purposes of illustration and description. It is not intended to be exhaustive or to limit the invention to the precise forms disclosed. This description and the claims following include terms, such as left, right, top, bottom, over, under, upper, lower, first, second, etc. that are used for descriptive purposes only and are not to be construed as limiting. For example, terms designating relative vertical position refer to a situation where a side of a substrate is the “top” surface of that substrate; the substrate may actually be in any orientation so that a “top” side of a substrate may be lower than the “bottom” side in a standard terrestrial frame of reference and still fall within the meaning of the term “top.” The term “on” as used herein (including in the claims) does not indicate that a first layer “on” a second layer is directly on and in immediate contact with the second layer unless such is specifically stated; there may be a third layer or other structure between the first layer and the second layer on the first layer. The embodiments of a device or article described herein can be manufactured, used, or shipped in a number of positions and orientations. Persons skilled in the relevant art can appreciate that many modifications and variations are possible in light of the above teaching. Persons skilled in the art will recognize various equivalent combinations and substitutions for various components shown in the Figures. It is therefore intended that the scope of the invention be limited not by this detailed description, but rather by the claims appended hereto.

What is claimed is:

1. A system comprising:
a driving unit;
a driven unit configured to be driven by the driving unit;
first and second cables coupling the driving unit to the driven unit;
wherein the driving unit comprises:
a motor;
a spool upon which the first and second cables are wound;
a shaft upon which the spool is mounted;
wherein the driven unit comprises:
a pulley;
a dynamic block;
a static block.

2. The system of claim 1, wherein:
the spool includes a central aperture and the shaft is included in the central aperture;
the spool includes an outer surface with a groove;
the first and second cables are included in the groove;
the central aperture is threaded with threads;
the shaft is threaded with threads that cooperate with the threads of the central aperture.

3. The system of claim 2, wherein:
the groove on the outer surface of the spool includes a first pitch;
the threads of the central aperture include a second pitch that equals the first pitch.

4. The system of claim 3, wherein:
the motor is configured to rotate the spool;
the spool is configured to translate along the shaft in response to the motor rotating the spool.

5. The system of claim 4, wherein the first and second cables are configured to move in opposing directions in response to the motor rotating the spool.

6. The system of claim 4, wherein the first cable is configured to maintain a consistent tension while the spool translates along the shaft in response to the motor rotating the spool.

7. The system of claim 4, wherein:
the driving unit includes a channel;
the first cable is included in the channel;
the first cable unwinds from the spool and enters the channel at a static angle while the spool translates along the shaft in response to the motor rotating the spool.

8. The system of claim 7 comprising a spring to increase a distance between the channel and the spool as an overall length of the first cable increases over time.

9. The system of claim 7 comprising a spring to increase a distance between the channel and the spool as the first cable fatigues over time.

10. The system of claim 1, wherein the first and second cables are not monolithic with each other.

11. The system according to claim 10, wherein the first and second cables terminate at the driven unit.

12. The system of claim 1 wherein:
the pulley rotates about a central axis;
the dynamic block is configured to rotate about the central axis in response to the motor rotating the spool.

13. The system of claim 12, wherein the first cable is configured to maintain a consistent tension while the dynamic block rotates about the central axis in response to the motor rotating the spool.

14. The system of claim 13, wherein the driven unit includes a force sensor to sense force exerted on the static block.

15. The system of claim 13, wherein the driven unit includes a force sensor to sense torque of the driven unit.
